(19) United States
(12) Patent Application Publication
(10) Pub. No.: US 2023/0029060 A1
(43) Pub. Date: Jan. 26, 2023

(54) DE-PALLETIZING AND DE-CASING SYSTEM

(71) Applicant: Conveyor & Automation Technologies, Inc., Sparks Glencoe, MD (US)

(72) Inventor: Gus SARIKAS, Sparks Glencoe, MD (US)

(21) Appl. No.: 17/811,636

(22) Filed: Jul. 11, 2022

Related U.S. Application Data
(60) Provisional application No. 63/224,041, filed on Jul. 21, 2021.

(51) Int. Cl. B65G 61/00; B65G 59/02; B25J 9/16; G06T 7/50

(52) U.S. Cl. CPC B65G 61/00; B65G 59/02; B25J 9/1687; G06T 7/50; G06T 2207/10028

(57) ABSTRACT

A de-palletizing system comprises a three-dimensional scanner; a robotic arm; and a control unit connected to the three-dimensional scanner and the robotic arm. The three-dimensional scanner takes a picture of a top layer of a pallet and transmits picture data to the control unit. The control unit is configured to receive the picture data from the three-dimensional scanner, process the picture data to create a depth map of the individual products and determine locations of individual products, and control the robotic arm to move a product grouping from a pick up location to a product drop off location.

### FIELD OF THE INVENTION

The invention relates generally to a system for de-palletizing and de-casing product groupings and, in particular, to a system and method for removing product groupings from a pallet, removing the case of the product grouping, and depositing the product grouping and the case at different drop off locations.

### BACKGROUND

Consumer products are typically packed in product cases. The product cases contain product groupings, which are a combination of the same or different type of product. The cased products, generally have the same packaging to facilitate grouping and casing of the product. The product groupings, in their cases, are then placed on pallets in multiple stacks from the factory to a distribution site. In some instances, product is removed from the pallet and separated from the case once the product arrives at the distribution site. The product is separated from its casing for a number of different reasons, such as for repackaging, reorganizing, changing the number of units per case. The de-palletizing and de-casing process is typically carried out by hand. In some instances, robots can be used for removing the cases from the pallets, however, the electronic mechanisms are still very slow. It is difficult to train robots to recognize specific product groupings. Furthermore, if there is any change or shift in the product distribution, the robotic arms register a fault, stop their process, and are incapable of completing the process without human intervention.

### SUMMARY OF THE INVENTION

A de-palletizing system comprises a three-dimensional scanner; a robotic arm; and a control unit connected to the three-dimensional scanner and the robotic arm. The three-dimensional scanner takes a picture of a top layer of a pallet and transmits picture data to the control unit. The control unit is configured to receive the picture data from the three-dimensional scanner, process the picture data to determine locations of individual products and create a depth map of the individual products, and control the robotic arm to move a product grouping from a pick up location to a product drop off location.

A method for de-palletizing product groupings. The method begins by placing a pallet on a de-palletizing system comprising a three-dimensional scanner; a robotic arm; and a control unit connected to the three-dimensional scanner and the robotic arm. The three-dimensional scanner takes a picture of a top layer of a pallet and transmits picture data to the control unit. The control unit is configured to receive the picture data from the three-dimensional scanner, process the picture data to determine locations of individual products and create a depth map of the individual products, and control the robotic arm to move a product grouping from a pick up location to a product drop off location.

### BRIEF DESCRIPTION OF THE FIGURES

The above and other features, aspects, and advantages of the present invention are considered in more detail, in relation to the following description of embodiments thereof shown in the accompanying drawings, in which:

FIG. 1 is a wire diagram of a method of de-casing product.

FIG. 1A is a schematic diagram of the image captured by a three-dimensional scanner.

FIG. 1B is a depth-map developed by a control unit.

FIG. 2 is a wire diagram of a method of de-casing product.

FIG. 3 is a wire diagram of a further method of de-casing product.

FIG. 4 is a wire diagram of a further method of de-casing product.

### DETAILED DESCRIPTION

The invention summarized above and defined by the enumerated claims may be better understood by referring to the following description, which should be read in conjunction with the accompanying drawings in which like reference numbers are used for like parts. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

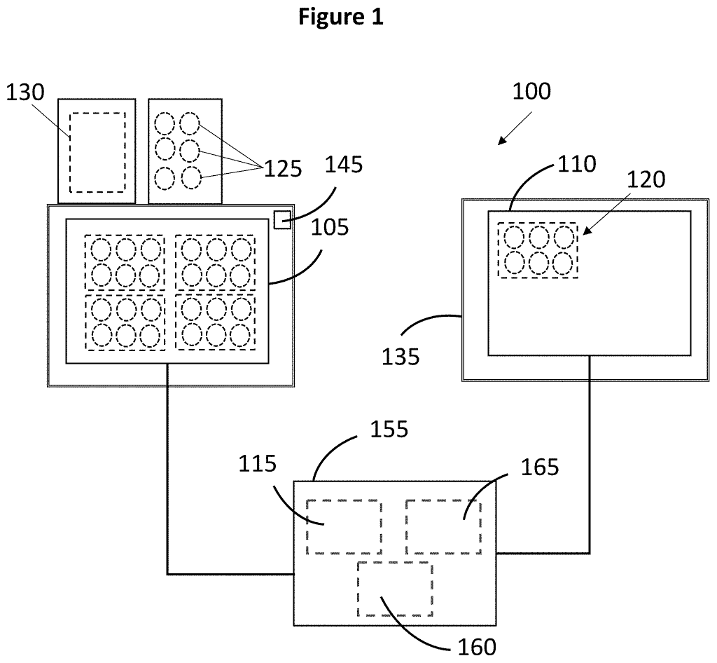

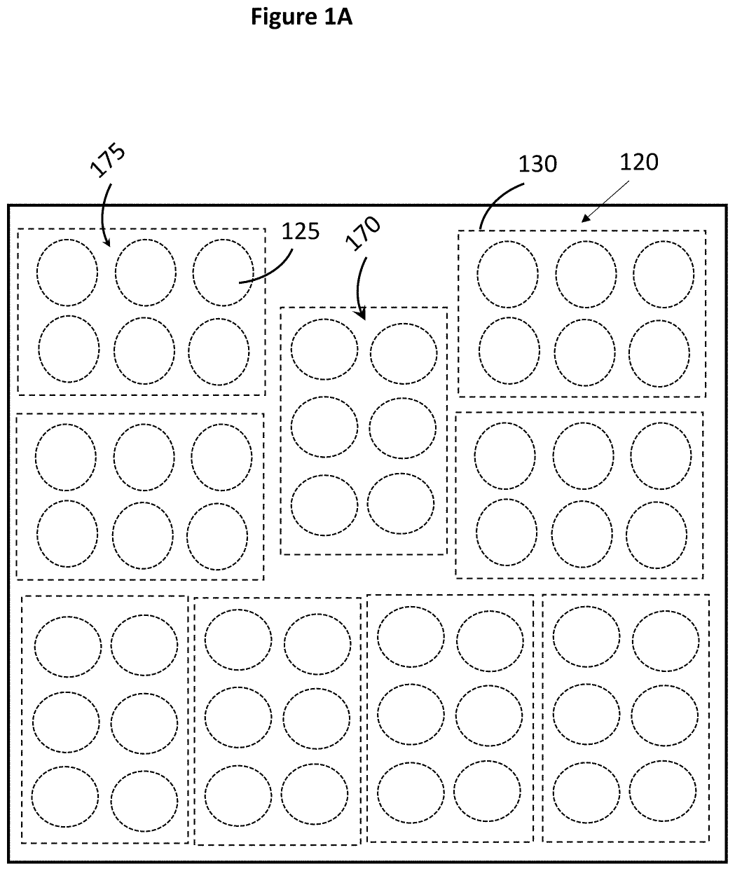

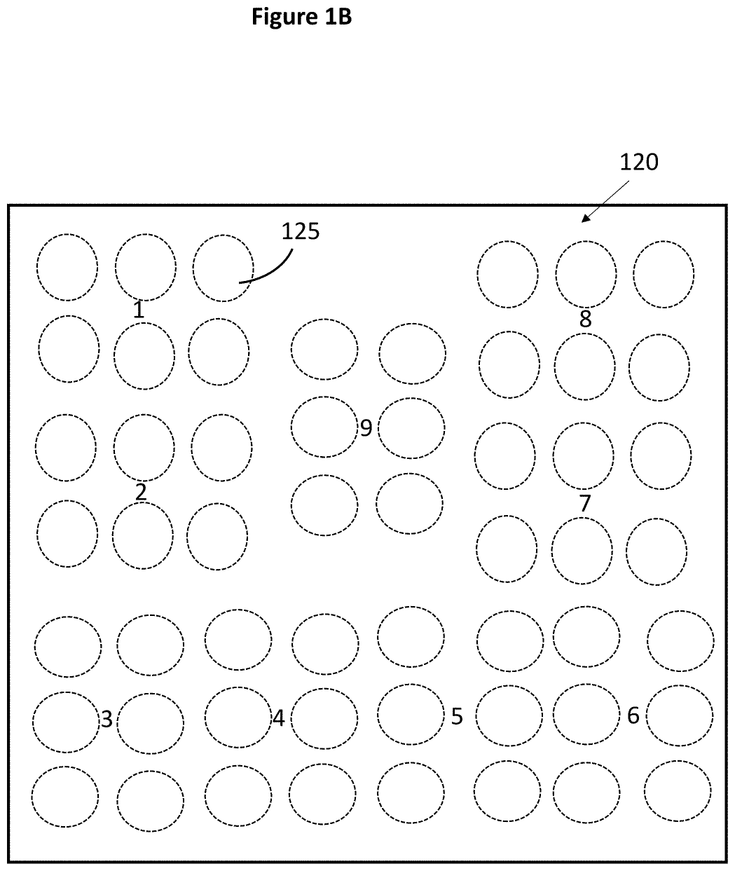

A product de-palletizing and de-casing system 100, as shown in FIG. 1, has the following components: a three-dimensional scanner 110, a control unit 115, and a robotic arm 105. The system 100 is configured to identify a product grouping 120, remove the product grouping 120 from a pallet 135 and deposit the product grouping 120 at a product drop off location. In some embodiments, the system 100 also includes a pallet sensor 145, connected to the control unit 115 or a programable logic controller 165. The pallet sensor 145 indicates to the system that a pallet 135 is in the pick-up location for product pick up.

The system 100, in some embodiments, also comprises a user interface 160 and a programable logic controller 165, which is another processor to manage the system 100. The user interface 160 allows the users to monitor the status of the system 100, to enter required information for the system 100 to recognize and move product groupings 120. The user interface 160 comprises a output device, such as a screen, and an input device, such as a keyboard. In some embodiments, the user interface 160 is a touch screen or the combination of a screen and a keyboard that allows the user to enter and view information. Other user interfaces may include any desktop computer, laptop computer, tablet, mobile phone or other electronic device configured to connect to the system 100. The user interface 160 may also be any stationary, portable, and/or handled electronic device that can connect to the system 100.

The programable logic controller 165 processes information and manage the system 100. In such configuration, the control unit 115 controls the robotic arm 105, while the programable logic controller 165 controls the other components of the system 100, such as conveyor belts, sensors, and other similar components. In some embodiments, a programable logic controller 165 is also available. The control unit 165 is configured to store the pattern of product grouping. The control unit 115, programable logic controller 165 and user interface 160 are contained within a single structure in some embodiments. In other embodiment, however, the control unit 115, user interface 160, and programable logic controller 165 are separate units located apart from each other and wired or wirelessly connected to each other. The programmable logic controller 165 also monitors multiple control units 115 and robotic arms 105. The system 100, may include multiple control units 115, robotic arms 105, and three-dimensional scanners 110, where each control unit 115 controls one or more robotic arms 105. The programmable logic controller 165 also manages the various control units 115 of the system 100.

The control unit 115 and programmable logic controller 165 comprise processors, such as microprocessors, microcontrollers, and any other type of processor that can store and process data and instructions for managing the system 100, including the system's 100 various components such as the robotic arm 105, three-dimensional scanner 110, and user interface 160. The various components of the system communicate with each other through any available network connections. The components may be part of a wide-area network (WAN), a local area network (LAN), a personal area network (PAN), wireless local area network (WLAN), or any other intranet or internet network, or combinations of any of those networks. Communications can be conducted over wired, wireless, cellular, Wi-Fi, blue-tooth or other similar communication networks. The system 100 may include any other cloud base, server-based, or local based storage devices. The system may further include non-volatile storage media, such as a hard drive, flash drive, removable optical disk, connected to the control unit 115 or programmable logic controller 165. Although the present embodiment shows a separate control unit 115 and programmable logic controller 165, it is understood that a single control unit 115 or a single programmable logic controller 165 may perform all the programmable functions of the system 100.

The control unit 115 and programmable logic controller 165 can each be configured (for example, by using corresponding programming stored in memory as well understood by those skilled in the art) to carry out one or more of the steps, actions, and/or functions described herein. In some embodiments, the memory may be integral to the control unit 115 or programmable logic controller 165 or can be physically discrete (in whole or in part) from the control unit 115 or programmable logic controller 165 and is configured to non-transitorily store the programs that, when executed by the control unit 115 or programmable logic controller 165, implement the method described in this application. As used herein, this reference to “non-transitorily” will be understood to include both non-volatile memory (such as read-only memory (ROM) as well as volatile memory (such as an erasable programmable read-only memory (EPROM). Accordingly, the memory and/or the control unit 115 may be referred to as a non-transitory medium or non-transitory computer readable medium.

An individual product 125 is any type of packaged item. Individual product 125 include drinks, sodas, sport drinks, food, and any other type of item packaged for distribution. The individual product 125 is packed in bottles, cans, boxes, and other similar containers. Individual product 125 can be packed as a product grouping 120 of units in a case 130, which are in turn arranged on a pallet 135.

Individual product 125 is generally packaged in product groupings 120, where the product groupings 120 are collections of individual product 125. Each product grouping 120 is packaged in a case 130. The combination of cases 130 contain the product groupings 120, while on the pallet 135. The system 100, in some embodiments, can separate the product grouping 120, from the case 130, should the system 100 need to perform subsequent operations to the individual products 125 after de-casing. The system 100, is configured to place the product groupings 120 at a product drop off location and the case 130 at a case drop off location. In one embodiment, the case 130 is dropped off first and placed at the case drop off location. The product grouping 120 is then dropped off at a product drop off location.

The system 100 identifies the layout of the individual product 125 and assigns them to product groupings 120 on the pallet 135. The system 100 utilizes a three-dimensional scanner 110 to take pictures of the pallet 135 that contains the cases 130 of individual product 125 arranged in product groupings 120. The control unit 115 uses the picture data from the three-dimensional scanner to measure various dimensions of each individual product 125 and assign product groupings 120 based on the information received from the three-dimensional scanner 110. The system 100 based all the calculations in the information received about the individual product 125. The system 100 does not receive or sense information or data about the case 130 in which the individual products 125 are placed. Although, the three-dimensional scanner 110 may include the case 130 in the data that it sends to the control unit 115, in some embodiments, only the information concerning the individual product 125 locations is utilized to control the robotic arm 105.

The three-dimensional scanner 110 takes two pictures from slightly different locations of the uppermost layer of individual product 125 to provide three-dimensional information to the control unit 115. The two pictures allow the control unit 115 to generate a depth map or point cloud of the top layer of individual product 125 on the pallet 135. A person of ordinary skill in the art would understand that any available three-dimensional type of sensor can be used to provide the control unit the information required to identify individual products 125. Thus, the system, may receive two or more pictures to use as information from the three-dimensional scanner 110 to create the depth map. As shown in FIG. 1A, the three-dimensional scanner 110 provides a picture of the various product units 125. A user interface 160 for the system 100 may show the distribution in various different ways. For example, the user interface 160 may show the various elements that it sees depending on the distance from the three-dimensional scanner 110 as calculated by the control unit 115 based on the pictures collected from the three-dimensional scanner 110. In some embodiments, the top of the individual product 125 may be displayed in one color as the individual product 125 is determined to be closest to the three-dimensional scanner 110. The top edge of the case 130 that contains the individual product 125 is represented in a different color as it is further from the three-dimensional scanner 110, however, only the individual product 125 information is utilized by the control unit 115 to determine the product groupings 120 and control the robotic arm 105. It is understood that a person of ordinary skill in the art would recognize that there are many ways in which the system may display to the user the distribution of individual products 125 and product groupings 120.

FIG. 1B shows a depth map or point cloud composed by the control unit 115. The depth map corresponds to the top layer of the individual products 125. Each dashed circle in FIG. 1B corresponds to the top of each individual product 125. In addition to identifying the location of each individual product 125, the control unit 115 also determines what type of product is on the pallet 135 and assigns the product groupings 120 on the pallet based on the information stored in the system 100 that matches the expected top layer of point distributions. For example, if the individual products 125 are soda bottles, the size of the circles will correspond to soda bottles, if the individual products 125 are soda cans the size of the circles will correspond to canned products.

In other embodiments, the indicators may have many different shapes. If the product is packed in a cubed package the footprint will be a square. The circles, squares, or other shapes are product type indicators. The product type indicators signal the system what type of product is on the pallet 135. In some embodiments, an individual user may enter the type of individual product 125 to be moved from a pick up location to a product drop off location through the user interface 160. This functionality is available to allow the system 100 to function when individual product 125 distribution is not found in the programable logic controller 165.

In some instances, such product type indicators tell the system whether the individual product 125 are stable or unstable. As explained in more detail below, a stable product is one that is not expected to shift or move when the robotic arm 105 moves a product grouping 120 from the pallet 135. The unstable product is a product that is likely to shift when the robotic arm 105 moves a product grouping 120 from the pallet 135. In certain instances, the distribution of the individual product 125 is such that the picture from the three-dimensional scanner cannot distinguish between product groupings 120, for instance, when the cases 130 are very thin or the sides are too short for the outline to be captured in the picture. In other instances, the shape of the individual product 125 packaging may be such that its sides protrude beyond the case wall and, thus, the case is not readily distinguished by control unit 115 from pictures collected by the three-dimensional scanner 110.

The three-dimensional scanner 110 sends the pictures to the control unit 115. The control unit 115 determines the depth map or point cloud of the top layer, that is, it measures the distance between the top of the individual product 125 and the three-dimensional scanner 110. The control unit 115 processes the information provided by the three-dimensional scanner 110, then assigns product groupings 120 and controls the robotic arm 105 to pick up product groupings 120 at the locations identified by the scanner 110.

The robotic arm 105 is configured to collect product groupings 120 from the pallet 135. The robotic arm 105 includes end of arm tooling that allows the robotic arm 105 to secure product groupings 120 and product cases 130 and lift them from the pallet 135. The robotic arm 105 is further configured to separate the product grouping 120 from their case 130. The robotic arm 105 places the product grouping 120 free of the case 130 at a product location and the case 130 at a case location. In some embodiments, the robotic arm 105 has retrieval tool at the one end of the robotic arm 105 to capture and remove product groupings 120. The retrieval tool in some embodiments is a pneumatic removal tool, a hydraulic removal tool, or a mechanical removal tool. The retrieval tool locks onto the top of each individual product 125 to pull the product grouping 120 from the pallet 135. In other embodiments, the robotic arm 105 has a product retrieval tool that locks onto the individual product mechanically or by way of friction locks, suction cups, or any other mechanism that allows the product retrieval tool to lock onto the individual product 125 for removal from the pallet 135. Other retrieval tools may be utilized as separate devices that grip the product and grip the casing and that can be actuated independently such that the case and product can be dropped off separately.

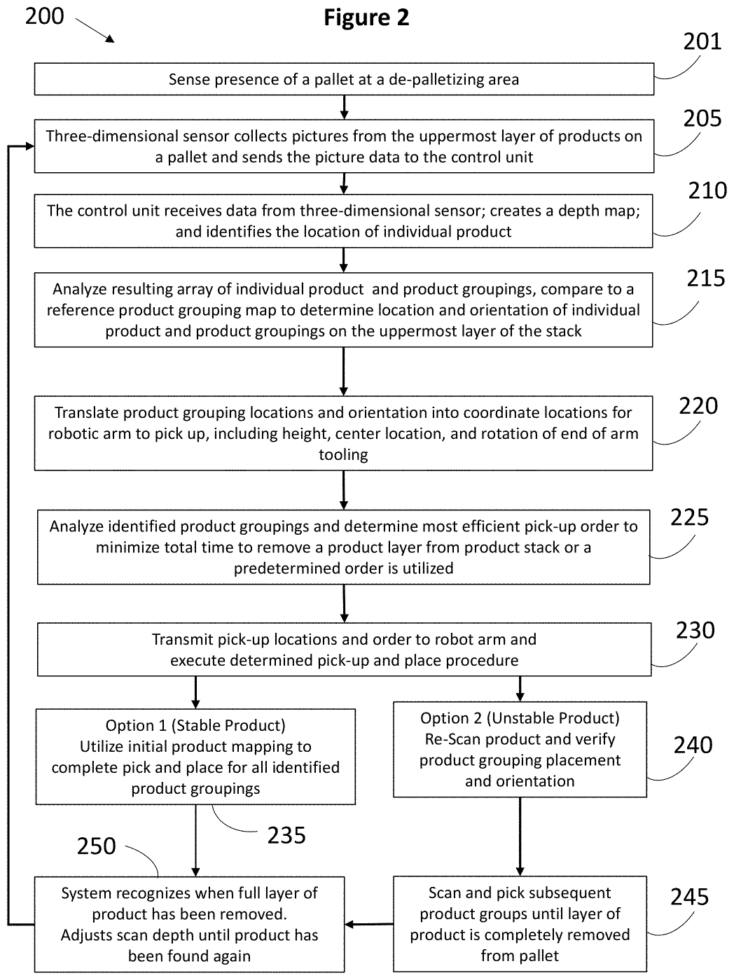

The system 100 implements a method 200 for de-palletizing and de-casing product as described on FIG. 2. In one step 201, the system 200 senses the presence of a pallet 135 at a depalletizing area. In some embodiments, step 201 is carried out by any type of sensor 145 that alerts the control unit 115 that there is a pallet 135 to be unloaded and product groupings 120 to be de-cased. In some embodiments, the sensor is a weigh sensor 145 that is triggered when the pallet 135 is placed at the de-palletizing location. The sensor, in other embodiments, is an infrared sensor that is triggered when any item is placed in the de-palletizing location. In other embodiments, a three-dimensional scanner 110 is triggered when a pallet 135 is placed at the de-palletizing location.

In a subsequent step 205, a three-dimensional scanner 110 collects pictures from the uppermost layer of individual products 125 on a pallet 135 and sends the picture data to the control unit 115. The data collected from the uppermost layer includes the distance of each individual product 125 from the three-dimensional scanner 110, which is utilized to create the depth map or point cloud of the individual products 125 on the pallet 135. The data the three-dimensional scanner 110 collects includes identifying features of the individual products 125, such as bottle caps, corners of boxes, geometry of the lids, or other consistent geometric features at the top/highest point, of the individual products 125 to be removed from the pallet 135.

At the next step 210, the control unit 115 creates a depth map of the individual product 125 and assigns product groupings 120 by identifying the location of the individual product 125. The control unit 115 is programed to understand that, if the control unit 115 identifies a specific height for an individual product 125, there are supposed to be a specific number of layers in a pallet 130 with a specific number of product groupings 120 on each layer. In some embodiments, a user can enter the number of layers in a pallet 130 through the user interface 160. The user can enter this information manually or select the pallet information from a list of pre-programmed options. Selecting pre-programmed options, user induced errors are minimized.

The control unit 115 analyzes the depth map to identify location of pre-determined identifying features of the individual product 125. The depth map corresponds to a reference product array of the individual products 125. The control unit 115, in step 215, then analyzes the resulting depth map of individual product 125 and compares the depth map to a reference product array to determine location of individual product 125 on the uppermost layer of the stack.

The control unit 115 identifies the individual product 125 to determine distribution, for example whether the individual product 125 is in product groupings 120 of, for example, eight (8), twelve (12), twenty-four (24), or thirty-six (36) individual products 125. For example, a 24 pack will be a grouping of 6×4 bottles, with a certain amount of space between them. The control unit 115 essentially compares the expected 6×4 set of circles to the circles present on the depth map. It is understood that the circles identify a feature of the individual product 125 in general; the top of the individual product may be a square, rectangle, or any other shape chosen by the manufacturer. If a group of circles matches, the control unit 115 marks the group as a full pack ready to be picked up. The control unit 115 compares the expected grouping to what the depth map shows on the pallet 135, with an allowed amount of deviation/error. The product groupings 120 are moved from the pick up location to the product drop off location in an order based on the reference product array that matches the depth map.

Product groupings 120 can be arranged in various configurations. For example, a product grouping 120 can be in a horizontal 175 or a vertical 170 arrangement. The arrangement of the product groupings 120 on the pallet 135, determines the configuration of the robotic arm 105 for capturing the product groupings 120 and lifting them from the pallet 135. In some instances the cases 130 in which the product groupings 120 are presented are clearly definable. In other instances, the cases 130 are not readily definable. When the product groupings 120 arrangements cannot be easily identifiable, a traditional robot is unable to distinguish the product groupings 120 and the system 100 is unable to accurately assign the product groupings 120 for transfer and de-casing. When the product grouping 120 orientation is not readily identified by the system 100, the system 100 relies upon a pre-determined pattern of vertical/horizontal arrangements stored in the programmable logic controller 165.

This technical problem is solved by providing the system 100 with an approximate location of the next case to be picked and the orientation of the product grouping, either vertical or horizontal. The approximate location of the product grouping is defined by a corner of the layer. This corner is either the top most left corner, or the left most top corner. The corner could also be the right most top or top most right. It could also be the bottom most left corner, the left most bottom, the bottom most right, or the right most bottom.

Once the corner is found, the three dimensional scanner 110 takes a picture and sends it to the control unit 115. The control unit then identifies product groupings in this corner to determine whether they are in a vertical arrangement 170, horizontal arrangement 175, or combination of arrangements. Each arrangement gets tagged with a number, i.e. the Vertical arrangement 170 is tagged with a 1 and the horizontal arrangement is tagged with a 2. The programmable logic controller 165 tells the control unit if it should be finding a vertical arrangement 170, or a horizontal arrangement 175. The control unit checks the first located product grouping 120 tag. If it equals what the programmable logic controller 165 told it, it picks the product grouping 120. If it does not equal, the control unit checks the next located product grouping 120. The control unit continues to check product groupings 120 until the tag matches what the programmable logic controller told it or there are no more found product groupings 120.

The control unit 115 then, in step 220, translates product grouping 120 locations into coordinate locations for the robotic arm to pick up the product groupings 120. The coordinates include, for example, height, center location, and rotation of end of arm tooling. The control unit 115 at step 225, analyzes the identified product groupings 120 and determines most efficient pick-up order to minimize total time to remove a product layer from the pallet 135. Essentially, the system determines the distance each pick up would need to travel (distance from pick up to the first drop off location, then back to the subsequent pick up location). The control unit 115 calculates the total number of pick ups and drop offs needed, and optimizes the order of picks that would result in the lowest overall distance travelled, thus the shortest time taken to accomplish all pick-ups and drop-offs. In some embodiments, the control unit 115 uses pre-determined pick up and drop off order to remove the product groupings 120 from the pallet. In such, embodiments, the control unit 115 does not have to calculate the pick up order.

The control unit 115 then transmits pick-up locations and order to robot arm and execute determined pick and place procedure in step 230. The pick up and drop off instructions follow two possible options depending on the stability of the individual product 125 and product groupings 120. Stable products are those which are not likely to shift when the pallets are being moved from one location to another. For example, if the product packaging for each individual product is a cube, it is unlikely that the individual product will shift when the robotic arm 105 picks up adjacent product groupings 120 from a pick up to a product drop off location. On the other hand, if the product is packaged in a spherical or irregularly shaped container, the individual product 125 are more likely to move to a different location when the robotic arm picks up an adjacent product grouping 125 from a pick up to a product drop off location, which results in the product groupings 120 being at a different location after a previous product grouping 120 is removed from the pallet 135.

In step 235, the first option for pick-up and drop-off relates to stable product, which means that the product groupings 120 fit a reference order for a stable product, or the distribution fits within a predetermined distribution of a stable product. When the product groupings match the expected distribution for a stable product, the robotic arm 105 is instructed to follow the fastest pick up distribution in a predetermined order without the need to re-scan the pallet after each pick up/drop off. The robotic arm 115 instructions include the location at which the product grouping 120 is dropped off and where the case 130 is dropped off after separated using the end of arm tooling of the robotic arm 115. In one embodiment, the case 130 is dropped off first at the case drop off location and the product grouping 120 is then dropped off at the product drop off location. In some embodiments, the case 130 is dropped off first and in other embodiments the product grouping 120 is dropped off first and the case are dropped second.

At step 250, the system 100 recognizes when full layer of product has been removed. The system 100 then adjusts scan depth until the next layer of individual product 125 and product groupings 120 is found and moves to step 205.

In an alternative to step 235, in step 240, the system 100 recognizes a distribution of individual product 125 labeled as an unstable product. In this alternative step 240, the three-dimensional scanner takes pictures from the pallet after each product grouping is picked up and dropped off. The control unit 115 sends updated instructions to the robotic arm 105 to ensure the robot has the correct coordinates for pick up. At step 245, the system 100 continues to scan and remove product until the product groupings 120 are completely removed from the pallet and de-cased. The method 200 continues until all the product groupings 120 are removed from the de-palletizing area.

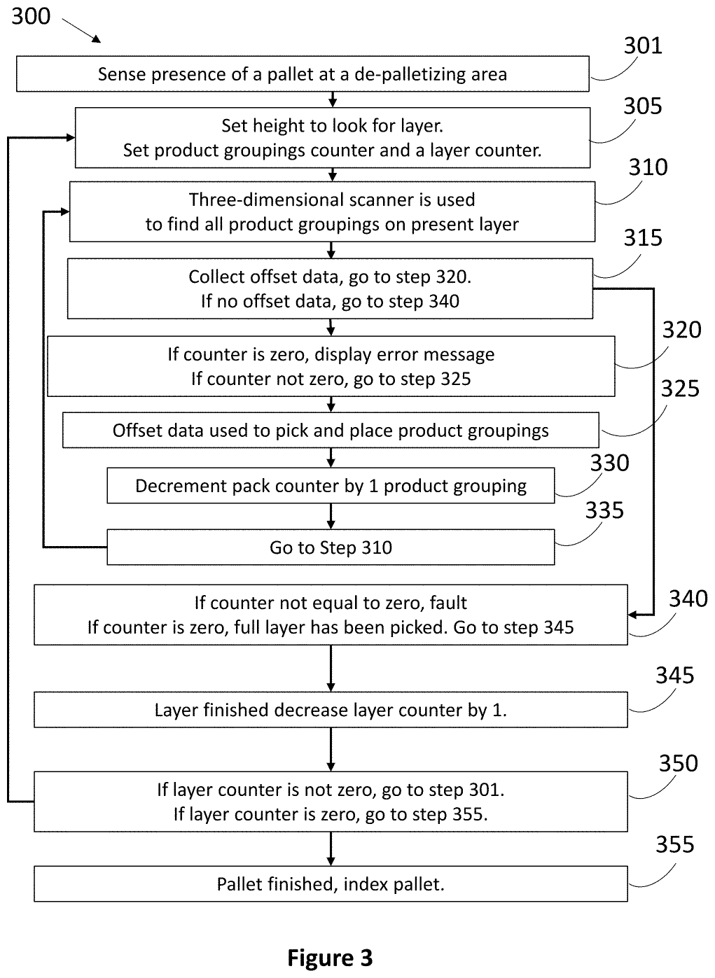

The method 300 of de-palletizing and de-casing product groupings that are unstable is shown in FIG. 3, from the perspective of the control unit 115 program. At the first step 301, the control unit 115 receives notification of the presence of a pallet 135 at the de-palletizing area. In the next step 305, a user may set the height to look for a layer and the product grouping 120 counter, which corresponds to the number of product groupings expected in each layer, and a layer counter to sets the number of layers on each pallet to be expected. In some embodiments, the number of layers and product groupings 120 are determined based on the information obtained from the three-dimensional scanner 110 in step 310. The control unit 115 is programed to understand that if the information from the three-dimensional scanner 110 relates to a specific height for an individual product 120, there are supposed to be a specific number of layers in a pallet 130 with a specific number of product groupings 120 on each layer. This sets a counter for the number of product groupings 120 expected in the layer and the number of layers. At step 315, the control unit 115, collect the offset data from the pictures provided by the three-dimensional scanner 110. Offset data refers to the individual product 125 and product groupings 120 coordinates identified by the control unit 115 from the pictures received from the three-dimensional scanner 110. If there is offset data the method 300 proceeds to step 320, if there is no offset data the method 300 proceeds to step 340.

At step 320, the control unit 115 checks the product grouping 120 counter. If the counter is zero, an error message is displayed. The user may then reset the product grouping 120 counter. If the counter is not zero, the method 300 proceeds to step 325, where the offset data is used to pick up a product grouping 120, de-case the product grouping 120, and drop the case 130 and product grouping 120 at designated locations. Once step 325 is completed, in step 330 the product grouping 120 counter is decreased by 1 product grouping 120 and the process then goes back to step 310, at step 335.

Once no offset data is sensed in step 315, the method 300 moves to step 340, where the control unit 115 checks the product grouping 120 counter. If the product grouping 120 counter is not equal to zero, the system 100 displays an error because the system was expecting another product grouping 120 to be present in the layer. If the product grouping 120 counter is zero, the control unit 115 recognizes that all the product groupings 120 in the layer have been picked from the stack and dropped off. The method 300, then moves to step 345 where the layer counter is decreased by 1 and the method moves onto step 350. At step 350, the control unit 115 checks the layer counter. If the layer counter is not zero, the method 300 proceeds to step 301 to continue removing product groupings 120 from the next layer. If the layer counter is zero, the method 300 moves to the final step 355 and the pallet is moved out of the depalletizing area to allow a new pallet to be placed at the pallet area.

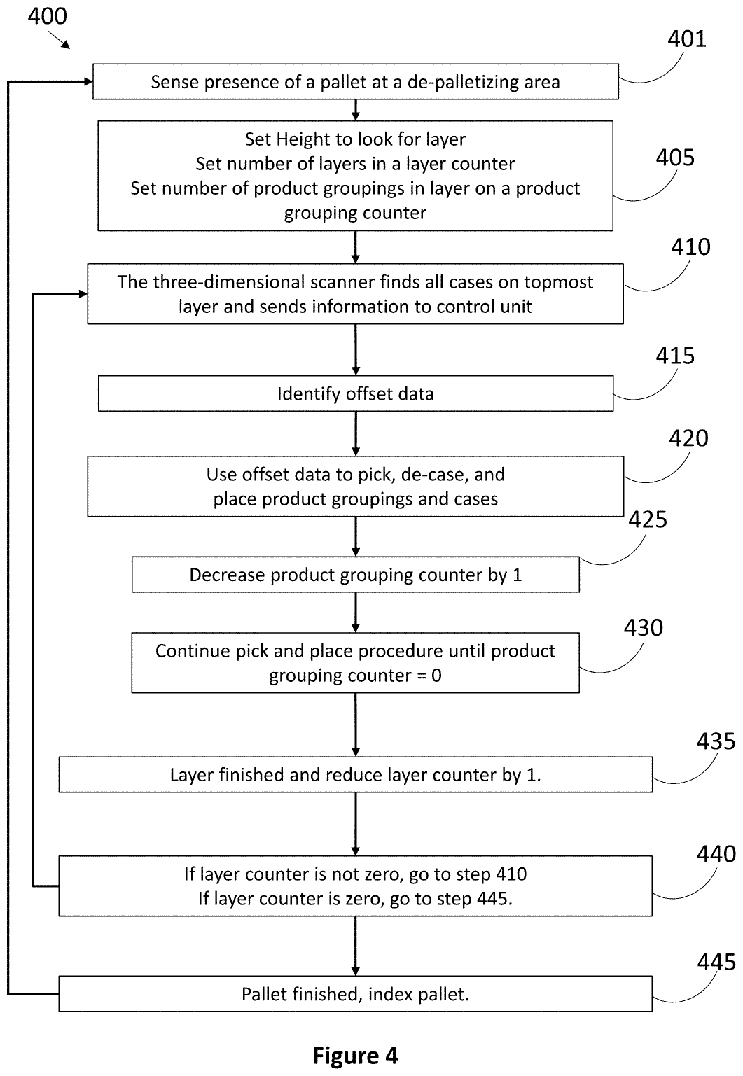

FIG. 4 describes one alternative embodiment of the method 400 of de-palettizing and de-casing product individual product 125 and product groupings 120 when the individual product 125 is identified as a stable product. In step 401, the system 100 senses the presence of a pallet at a depalletizing area. At step 405, a user sets the height to look for the top of the uppermost layer; set the number of layers in a layer counter; and sets number of product groupings 125 in the layer on a product grouping 120 counter. In some embodiments, the height is automatically set by the system and does not need to be set by the user.

The three-dimensional scanner 110 at step 410 takes a picture of the topmost layer and sends information to control unit 115. The control unit 115 identifies offset data for the product groupings 120 in the topmost layer. The offset data is used in step 415 to pick, de-case, and place product groupings and cases. Once the product grouping 120 is placed at designated location, the product grouping 120 counter is decreased by 1. The system 100 continues to pick and place product groupings 120 until the product grouping 120 counter equals zero. Once the product grouping 120 counter is equal to zero, the layer is finished and the layer counter is reduced by 1 in step 435. At step 440, the control unit 115 checks the layer counter. If the layer counter is not zero, the process continues to step 410. If the layer counter is zero, the method 300 moves to step 445 where the pallet is identified as finished and indexed; and the process starts again at 401.

It is contemplated that the individual products 125 may be uniform or non-uniform. Uniform product relates to those individual products 125 that have the same characteristics, such as same height in relation to the pallet, the layer, or identifying feature/geometry by which the tooling will pick up the product. Non-uniform product relates to combinations of individual products 120 where some class of products have different characteristics from each other, such as the height in relation to the pallet 130. If there are two different individual products 120 classes that the system 100 will accept, the control unit 115 looks for a height X for one class of individual product 120, and height Y for a second class of individual product 120. Once the three-dimensional scanner 110 sends product grouping 120 data with different heights, the control unit 115 will know what product is present in the layer at the palletizing area.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

1. A de-palletizing system, comprising:
a three-dimensional scanner;
a robotic arm; and
a control unit connected to the three-dimensional scanner and the robotic arm;
wherein, the three-dimensional scanner takes a picture of a top layer of a pallet and transmits picture data to the control unit,
the control unit is configured to
receive the picture data from the three-dimensional scanner,
process the picture data to determine locations of individual products and create a depth map of the individual products, and
control the robotic arm to move a product grouping from a pick up location to a product drop off location.

2. The system of claim 1, wherein the control unit is further configured to control the robotic arm by directing the robotic arm to the pick up location, directing the robotic arm to pick the product grouping from the pick up location, separate the product grouping from a case, and depositing the product grouping at the product drop off location.

3. The system of claim 2, wherein the control unit causes the robotic arm to deposit the case at a case drop off location.

4. The system of claim 1, wherein the control unit is configured to identify stable product and unstable product.

5. The system of claim 4, wherein the product grouping comprises stable product and the product grouping is picked up in a predetermined order without further scanning.

6. The system of claim 4, wherein the product grouping comprises unstable product, the system is configure to have the three-dimensional scanner take pictures from the pallet after each product grouping is picked up and dropped off, and the control unit is configured to process the pictures and controls the robotic arm to pick up product groupings after each scan.

7. The system of claim 1, wherein the control unit compares the depth map to a reference product grouping.

8. The system of claim 7, wherein the product groupings are moved from the pick up location to the product drop off location in an order based on the reference product array that matches the depth map.

9. The system of claim 1, wherein the reference product array comprises a distribution of product groupings in horizontal, vertical, or combinations of horizontal and vertical arrangements of product groupings.

10. The system of claim 1, further comprising a programmable logic controller.

11. The system of claim 10, wherein the programmable logic controller is configured to identify location and orientation of the product grouping and further provide information to the control unit.

12. The system of claim 11, wherein the programmable logic controller is configured to store product grouping distribution locations based on layer and cycle number.

13. The system of claim 10, wherein the programmable logic controller is configured to process information and manage the system.

14. The system of claim 13, wherein the programable logic controller manage system components, including conveyor belts, sensors, control units, user interfaces, and robotic arms.

15. The system of claim 1, further comprising a pallet sensor.

16. The system of claim 15, wherein the pallet sensor is connected to the control unit and sends a signal to the control unit when the pallet is sensed at the pick up location.

17. The system of claim 15, wherein the pallet sensor is connected to the programable logic controller and sends a signal to the programable logic controller when the pallet is sensed at the pick up location.

18. The system of claim 1, further comprising a user interface connected.

19. The system of claim 18, wherein the user interface comprises an output and input device.

20. (canceled)

21. (canceled)

22. (canceled)

23. (canceled)

21. A method for de-palletizing product groupings, comprising:
placing a pallet on a de-palletizing system comprising
a three-dimensional scanner;
a robotic arm; and
a control unit connected to the three-dimensional scanner and the robotic arm;
wherein, the three-dimensional scanner takes a picture of a top layer of a pallet and transmits picture data to the control unit,
the control unit is configured to
receive the picture data from the three-dimensional scanner, create a depth map of the individual products and
processes the picture data to determine locations of individual products, and
control the robotic arm to move a product grouping from a pick up location to a product drop off location;
instructing the system to de-palletize the product groupings from the pallet.

25.-44. (canceled)
